(19) United States
(12) Patent Application Publication
(10) Pub. No.: US 2026/0348413 A1
(43) Pub. Date: Nov. 5, 2026

(54) PLUG-IN CONNECTING BUCKLE, COMBINED RACK AND DRAIN RACK

(71) Applicant: Jiangmen Lede Home Furnishing Co., Ltd., Jiangmen (CN)

(72) Inventor: Bian CAI, Jiangmen (CN)

(73) Assignee: Jiangmen Lede Home Furnishing Co., Ltd., Jiangmen (CN)

(21) Appl. No.: 19/244,632

(22) Filed: Jun. 20, 2025

(30) Foreign Application Priority Data
Apr. 30, 2025 (CN) 2025208556870

(51) Int. Cl. F16B 7/04; A47L 19/04

(52) U.S. Cl. CPC F16B 7/048; A47L 19/04

(57) ABSTRACT

A plug-in connecting buckle, a combined rack and a drain rack are disclosed. The plug-in connecting buckle includes: a first connecting part provided with a first positioning groove and a first clamping groove which are communicated with each other and have downward openings, the first positioning groove being configured for inserting a first cross bar and driving the first cross bar to be clamped in the first clamping groove; and a second connecting part integrally connected with the first connecting part and provided with a second positioning groove and a second clamping groove which are communicated with each other and have downward openings, the second positioning groove being configured for inserting a second cross bar and driving the second cross bar to be clamped in the second clamping groove.

### CROSS-REFERENCE TO RELATED APPLICATION

This application is based on and claims the benefit of priority from Chinese Patent Application No. 2025208556870, filed on Apr. 30, 2025, the entirety of which is incorporated by reference herein.

### TECHNICAL FIELD

The present disclosure relates to the technical field of connecting structures, and in particular to a plug-in connecting buckle, a combined rack provided with a plug-in connecting buckle and a drain rack provided with a plug-in connecting buckle.

### BACKGROUND

Existing methods for connecting bar racks mainly comprise welding connection, bolt or nut connection and so on. Welding process is complex, requiring professional equipment which has to be operated by technicians. Moreover, in the welding process, a welded part is prone to deformation due to thermal stress, which affects an overall structural accuracy of the bar rack. More importantly, once the welded part has problems and needs maintenance, it is difficult to repair just the problematic welded part, and it is often necessary to replace the bar rack as a whole or weld the bar rack again after cutting, making later maintenance very challenging. In addition, the bolt or nut connection adopts threaded fasteners to realize detachable connection of the bar rack, which has the advantage of convenient installation and maintenance. However, in practical application, it is necessary to pre-drill or tap holes in the bar rack, which undoubtedly increases the processing cost. Moreover, under the action of long-term vibration or external force, the bolt or nut is easy to loosen and needs to be checked regularly and re-tightened, otherwise it will affect the connection stability of the bar rack. In addition, the connecting part is exposed and easy to be corroded, which further affects the stability of the structure.

In addition, there are some common problems in connecting joints of some combined bar rack structures, such as poor anti-loosening performance. Over the long-term use, the connecting part is easy to loosen gradually due to vibration, external forces and other factors, which further affects the strength and stability of the whole bar rack structure. Moreover, the installation process is often complicated, which requires specialized tools or complex procedures, making rapid assembly difficult. This affects the construction efficiency to a certain extent. Especially, when a component in the connecting joint is damaged, it is difficult to maintain, and usually needs to destroy the original connecting structure to replace the component, which not only increases the maintenance cost, but also affects normal use of the bar rack.

### SUMMARY

The present disclosure aims at solving at least one of the technical problems in the existing technology. Therefore, the present disclosure provides a plug-in connecting buckle, which realizes fast and stable connection of a bar rack, adopts a dual positioning and clamping structure, is convenient and efficient to install, and does not need complicated tools. Moreover, multi-directional constraint enhances the connection stability, achieving high anti-loosening performance.

The present disclosure further provides a combined rack provided with the plug-in connecting buckle above and a drain rack provided with the plug-in connecting buckle above.

The plug-in connecting buckle according to the present disclosure comprises:
a first connecting part, wherein the first connecting part is provided with a first positioning groove and a first clamping groove which are communicated with each other, openings of the first positioning groove and the first clamping groove are both oriented downward, and the first positioning groove is configured for inserting a first cross bar and driving the first cross bar to be clamped in the first clamping groove; and
a second connecting part integrally connected with the first connecting part, wherein the second connecting part is provided with a second positioning groove and a second clamping groove which are communicated with each other, openings of the second positioning groove and the second clamping groove are both oriented downward, and the second positioning groove is configured for inserting a second cross bar and driving the second cross bar to be clamped in the second clamping groove.

The plug-in connecting buckle according to the present disclosure at least has the following beneficial effects. Efficient and stable connection between the first cross bar and the second cross bar can be realized through the design of integrated double connecting parts, for example, adjacent bar racks can be connected at the corresponding cross bars through the plug-in connecting buckle. The positioning grooves and the clamping grooves with downward openings form a step-by-step guide locking mechanism, so that positioning and locking of the cross bars can be completed only by vertical insertion, without additional tools. This significantly reduces the assembly difficulty, and improves the assembly efficiency. Moreover, it facilitates maintaining the bar racks corresponding to the first cross bar and the second cross bar after being disassembled in a later stage.

In the plug-in connecting buckle according to some embodiments of the present disclosure, a width of the first positioning groove is matched with an outer diameter of the first cross bar, and a width of the second positioning groove is matched with an outer diameter of the second cross bar.

In the plug-in connecting buckle according to some embodiments of the present disclosure, the first positioning groove is capable of allowing a first vertical bar connected with an end of the first cross bar to enter and positioning the first vertical bar; and the second positioning groove is capable of allowing a second vertical bar connected with an end of the second cross bar to enter and positioning the second vertical bar.

In the plug-in connecting buckle according to some embodiments of the present disclosure, the first clamping groove and the second clamping groove are arranged at a same horizontal position.

In the plug-in connecting buckle according to some embodiments of the present disclosure, the first clamping groove and the second clamping groove are vertically arranged.

In the plug-in connecting buckle according to some embodiments of the present disclosure, one side of the first connecting part away from the second connecting part is provided with a first clamping part, the first positioning groove is arranged on the first connecting part, and the first clamping groove is arranged on the first clamping part; and one side of the second connecting part away from the first connecting part is provided with a second clamping part, the second positioning groove is arranged on the second connecting part, and the second clamping groove is arranged on the second clamping part.

The combined rack according to some embodiments of the present disclosure comprises: a first bar rack provided with a first bar rack and a first vertical bar; a second bar rack provided with a second cross bar and a second vertical bar; and a plurality of plug-in connecting buckles, each of which being the plug-in connecting buckle described above, wherein the first connecting part is configured for insertion and positioning of the first cross bar and the first vertical bar, and the second connecting part is configured for insertion and positioning of the second cross bar and the second vertical bar, so as to fixedly connect the first bar rack and the second bar rack.

The combined rack according to the present disclosure at least has the following beneficial effects. Quick assembly and disassembly of the bar rack is realized by using the plug-in connecting buckle, without welding or bolt fastening. This greatly shortens a construction period and reduces a labor cost. At the same time, multi-directional constraint characteristics of the plug-in connecting buckle ensure that the combined rack maintains structural rigidity during transportation or use, and is especially suitable for temporary or variable structure scenarios where frequent disassembly occurs.

The drain rack according to some embodiments of the present disclosure comprises: a chassis which is horizontally arranged, wherein the chassis is adapted for placing tableware; a plurality of bar racks which are all vertically arranged, wherein the plurality of bar racks are respectively connected to a periphery of the chassis; and a plurality of plug-in connecting buckles, each of which being the plug-in connecting buckle described above, wherein adjacent bar racks of the plurality of bar racks are fixedly connected through the plug-in connecting buckle.

The drain rack according to the present disclosure at least has the following beneficial effects. Quick assembly of the bar rack and the chassis is realized through the plug-in connecting buckle, without welding or punching, which significantly reduces the manufacturing difficulty and the material loss. Moreover, the detachable characteristics of the buckle enable the bar rack to be folded to the chassis during storage, which greatly reduces space occupation and is convenient for transportation and storage. In addition, the separated design of the bar rack and the chassis allows a damaged part to be replaced independently, thus avoiding whole scrapping and improving product economy and environmental protection.

In the drain rack according to some embodiments of the present disclosure, a bottom of each of the bar racks is rotatably arranged on the chassis, and each of the bar racks is capable of being rotatably accommodated in the chassis after the respective plug-in connecting buckle is removed.

The drain rack according to some embodiments of the present disclosure further comprises a plurality of clamping blocks, each of the bar racks comprises a first telescopic rack and a second telescopic rack, and each of the clamping blocks is detachably connected to the respective first telescopic rack and the respective second telescopic rack, and drives the respective first telescopic rack to pull out from or slide into the respective second telescopic rack.

The additional aspects and advantages of the present disclosure will be given in part in the following description, and will become apparent in part from the following description, or will be learned through the practice of the present disclosure.

### BRIEF DESCRIPTION OF THE DRAWINGS

The above and/or additional aspects and advantages of the present disclosure will be more apparent from the following description of the embodiments in conjunction with the accompanying drawings, wherein:

FIG. 1 is a schematic structural diagram of a plug-in connecting buckle according to the embodiments of the present disclosure;

FIG. 2 is a schematic structural diagram of the plug-in connecting buckle according to the embodiments of the present disclosure applied to a combined rack;

FIG. 3 is a schematic structural diagram of the plug-in connecting buckle according to the embodiments of the present disclosure applied to a drain rack; and

FIG. 4 is a schematic structural diagram of the drain rack shown in FIG. 3 in a storage state.

### Reference numerals:

100—plug-in connecting buckle, 110—first connecting part, 111—first clamping part, 1101—first positioning groove, 1102—first clamping groove, 120—second connecting part, 121—second clamping part, 1201—second positioning groove, and 1202—second clamping groove;
200—combined rack, 210—first bar rack, 211—first cross bar, 212—first vertical bar, 220—second bar rack, 221—second cross bar, and 222—second vertical bar; and
300—drain rack, 310—chassis, 320—bar rack, 321—first telescopic rack, 322—second telescopic rack, and 330—clamping block.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “rear”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those of ordinary skill in the art can determine the specific meanings of the above words in the present disclosure in a rational way in combination with the specific contents of the technical solutions.

In the description of the present disclosure, the description with reference to the terms such as “an embodiment”, “some embodiments”, “illustrative embodiment”, “examples”, “specific examples” or “some examples” mean that the specific features, structures, materials or characteristics described in connection with the embodiment or example are included in at least one embodiment or example of the present disclosure. In the specification, the schematic representation of the above terms does not necessarily mean the same embodiment or example. Moreover, the specific features, structures, materials or characteristics described may be combined in any one or more embodiments or examples in a suitable manner.

Existing methods for connecting bar racks mainly comprise welding connection, bolt or nut connection and so on. Welding process is complex, requiring professional equipment which has to be operated by technicians. Moreover, in the welding process, a welded part is prone to deformation due to thermal stress, which affects an overall structural accuracy of the bar rack. More importantly, once the welded part has problems and needs maintenance, it is difficult to repair just the problematic welded part, and it is often necessary to replace the bar rack as a whole or weld the bar rack again after cutting, making later maintenance very challenging. In addition, the bolt or nut connection adopts threaded fasteners to realize detachable connection of the bar rack, which has the advantage of convenient installation and maintenance. However, in practical application, it is necessary to pre-drill or tap holes in the bar rack, which undoubtedly increases the processing cost. Moreover, under the action of long-term vibration or external force, the bolt or nut is easy to loosen and needs to be checked regularly and re-tightened, otherwise it will affect the connection stability of the bar rack. In addition, the connecting part is exposed and easy to be corroded, which further affects the stability of the structure.

In addition, there are some common problems in connecting joints of some combined bar rack structures, such as poor anti-loosening performance. Over the long-term use, the connecting part is easy to loosen gradually due to vibration, external forces and other factors, which further affects the strength and stability of the whole bar rack structure. Moreover, the installation process is often complicated, which requires specialized tools or complex procedures, making rapid assembly difficult. This affects the construction efficiency to a certain extent. Especially, when a component in the connecting joint is damaged, it is difficult to maintain, and usually needs to destroy the original connecting structure to replace the component, which not only increases the maintenance cost, but also affects normal use of the bar rack.

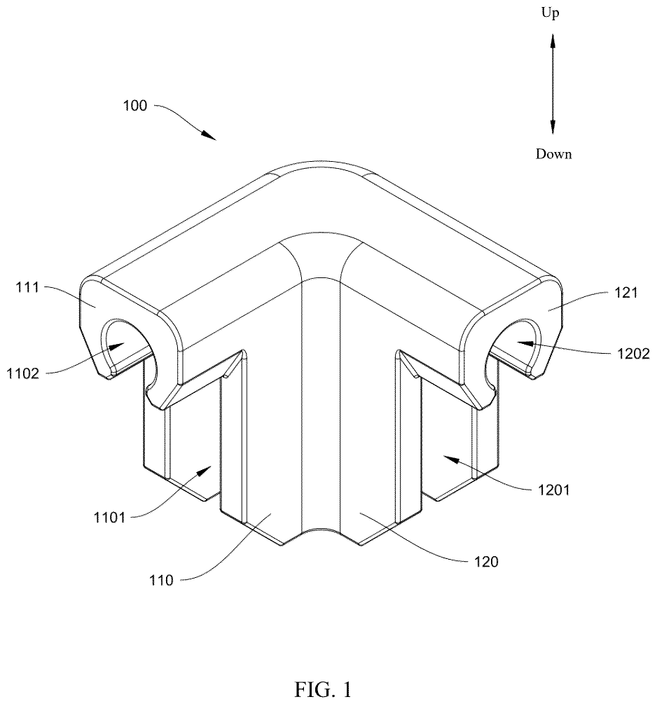

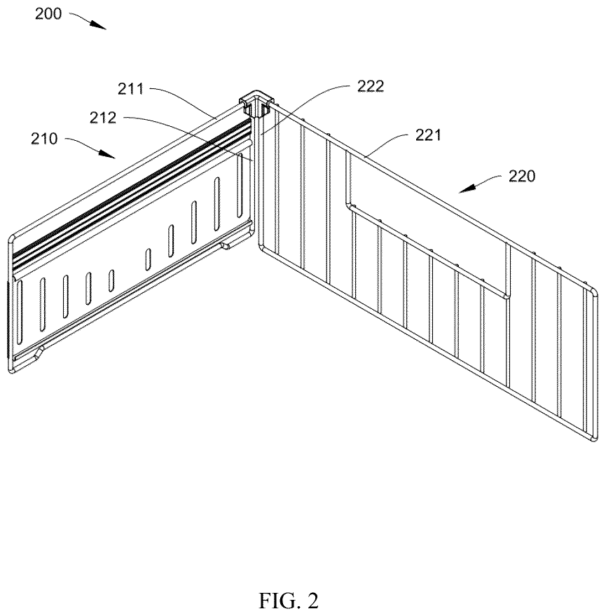

Therefore, as shown in FIG. 1, the present disclosure provides a plug-in connecting buckle 100 provided, comprising a first connecting part 110 and a second connecting part 120 integrally connected with the first connecting part 110. The first connecting part 110 is provided with a first positioning groove 1101 and a first clamping groove 1102 which are communicated with each other. The second connecting part 120 is provided with a second positioning groove 1201 and a second clamping groove 1202 which are communicated with each other. Further referring to FIG. 2, openings of the first positioning groove 1101 and the first clamping groove 1102 are both oriented downward, and the first positioning groove 1101 is configured for inserting a first cross bar 211 and driving the first cross bar 211 to be clamped in the first clamping groove 1102. Similarly, openings of the second positioning groove 1201 and the second clamping groove 1202 are both oriented downward, and the second positioning groove 1201 is configured for inserting a second cross bar 221 and driving the second cross bar 221 to be clamped in the second clamping groove 1202. It should be noted that efficient and stable connection between the first cross bar 211 and the second cross bar 221 can be realized through the design of integrated double connecting parts, for example, adjacent bar racks 320 can be connected at the corresponding cross bars through the plug-in connecting buckle 100. The positioning grooves and the clamping grooves with downward openings form a step-by-step guide locking mechanism, so that positioning and locking of the cross bars can be completed only by vertical insertion, without additional tools. This significantly reduces the assembly difficulty, and improves the assembly efficiency. Moreover, it facilitates maintaining the bar racks 320 corresponding to the first cross bar 211 and the second cross bar 221 after being disassembled in a later stage.

Further referring to FIG. 1 and FIG. 2, in some embodiments of the present disclosure, a width of the first positioning groove 1101 is matched with an outer diameter of the first cross bar 211, which can ensure that the first cross bar 211 can form a tight fit with first positioning groove 1101 after being inserted into the first positioning groove 1101, and avoid shaking or deviation caused by a gap. In this way, the first cross bar 211 can be better clamped into the first clamping groove 1102, further improving the structural stability and the anti-loosening performance of a connecting joint, and reducing abnormal sound or wear caused by vibration or external force in long-term use. Similarly, a width of the second positioning groove 1201 is matched with an outer diameter of the second cross bar 221, which can ensure that the second cross bar 221 can form a tight fit with second positioning groove 1201 after being inserted into the second positioning groove 1201, and avoid shaking or deviation caused by a gap. In this way, the second positioning groove 1201 can be better clamped into the clamped into 1202, improving the structural stability and the anti-loosening performance of a connecting joint, and reducing abnormal sound or wear caused by vibration or external force in long-term use.

Further referring to FIG. 2, taking a combined rack 200 for example, in some embodiments of the present disclosure, the combined rack 200 comprises a first bar rack 210 and a second bar rack 220. The first bar rack 210 is provided with a first cross bar 211 and a first vertical bar 212, and the second bar rack 220 is provided with a second cross bar 221 and a second vertical bar 222. In this regard, the first positioning groove 1101 is capable of allowing the first vertical bar 212 connected with an end of the first cross bar 211 to enter and positioning the first vertical bar 212. Similarly, the second positioning groove 1201 is capable of allowing the second vertical bar 222 connected with an end of the second cross bar 221 to enter and positioning the second vertical bar 222. Through the positioning function of the first positioning groove 1101 and the second positioning groove 1201 on the first vertical bar 212 and the second vertical bar 222 respectively, the bar rack 320 can be further restrained by the vertical bars on the basis of cross bar connection, thus enhancing the overturning resistance and the bearing stability of the whole structure, which is especially suitable for scenarios where it needs to bear external force or vibration, simplifying installation steps and completing multi-dimensional positioning without additional fixing devices.

Further referring to FIG. 1 and FIG. 2, in some embodiments of the present disclosure, the first clamping groove 1102 and the second clamping groove 1202 are arranged at the same horizontal position, which can ensure that the first cross bar 211 and the second cross bar 221 are in the same force bearing plane after insertion, and avoid local stress concentration or distortion caused by a height difference, thereby improving force bearing uniformity of the connecting joint, prolonging a service life and reducing a repair difficulty caused by structural deviation during maintenance. Further, the first clamping groove 1102 and the second clamping groove 1202 are vertically arranged, which are adapted to the first bar rack 210 and the second bar rack 220 connected at 90 degrees. The first cross bar 211 and the second cross bar 221 are locked by the plug-in connecting buckle 100, thus forming a right-angle locking structure. This significantly improves the shear resistance and the torsion resistance, and is especially suitable for the combined bar rack 320 that needs to bear complex external forces, such as lateral thrust or torsion. It is easy to understand that when the first bar rack 210 and the second bar rack 220 are connected at other angles, such as 30 degrees, 45 degrees, 70 degrees, 115 degrees, 130 degrees, and the like, an intersection angle between the first clamping groove 1102 and the second clamping groove 1202 may be designed as required according to the actual situation.

Further referring to FIG. 1, in some embodiments of the present disclosure, one side of the first connecting part 110 away from the second connecting part 120 is provided with a first clamping part 111, the first positioning groove 1101 is arranged on the first connecting part 110, and the first clamping groove 1102 is arranged on the first clamping part 111. Therefore, insertion paths of the first cross bar 211 and the first vertical bar 212 are separated and do not interfere with each other, which not only simplifies a step logic of a single insertion operation, but also realizes double locking effects through step-by-step clamping. This further improves the connection reliability, and facilitates the disassembly of a bar in a certain direction independently in a later stage without destroying the overall structure. For example, in application, the first vertical bar 212 and the first cross bar 211 with the same outer diameter move horizontally or vertically into the first positioning groove 1101, and then the first clamping part 111 moves downward to be clamped with the first cross bar 211. In this case, the first vertical bar 212 is abutted against the first positioning groove 1101 for position limiting. Similarly, one side of the second connecting part 120 away from the first connecting part 110 is provided with a second clamping part 121, the second positioning groove 1201 is arranged on the second connecting part 120, and the second clamping groove 1202 is arranged on the second clamping part 121. For the application and function of the second clamping part 121 in the second connecting part 120, reference may be made to the application and function of the first clamping part 111 in the first connecting part 110, which will not be repeated herein.

Further referring to FIG. 2, the combined rack 200 comprises a plurality of plug-in connecting buckles 100 according to an embodiment of the present disclosure, and further comprises a first bar rack 210 and a second bar rack 220, wherein the first bar rack 210 is provided with a first cross bar 211 and a first vertical bar 212, and the second bar rack 220 is provided with a second cross bar 221 and a second vertical bar 222. Specifically, the first connecting part 110 is configured for insertion and positioning of the first cross bar 211 and the first vertical bar 212, and the second connecting part 120 is configured for insertion and positioning of the second cross bar 221 and the second vertical bar 222, to fixedly connect the first bar rack 210 and the second bar rack 220.

In the combined rack 200 according to an embodiment of the present disclosure, quick assembly and disassembly of the bar rack 320 is realized by using the plug-in connecting buckle 100, without welding or bolt fastening. This greatly shortens a construction period and reduces a labor cost. At the same time, multi-directional constraint characteristics of the plug-in connecting buckle 100 ensure that the combined rack 200 maintains structural rigidity during transportation or use, and is especially suitable for temporary or variable structure scenarios where frequent disassembly occurs.

Other structures and operations of the combined rack 200 according to an embodiment of the present disclosure are known to those of ordinary skills in the art, and will not be described in detail here.

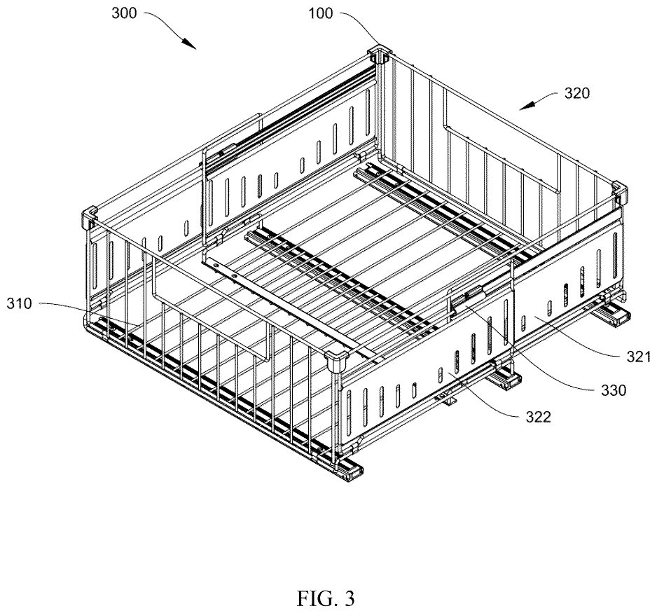

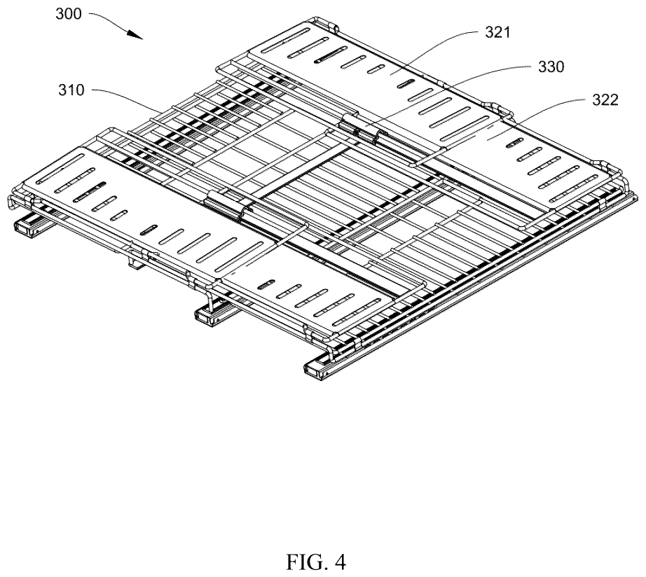

Further referring to FIG. 3, a drain rack 300 comprises a plurality of plug-in connecting buckles 100 according to an embodiment of the present disclosure, and further comprises a chassis 310 and a plurality of bar racks 320. The chassis 310 is horizontally arranged, and the chassis 310 is suitable for placing tableware. The plurality of bar racks 320 are all vertically arranged, and the plurality of bar racks 320 are respectively connected to a periphery of the chassis 310. Further, the adjacent bar racks 320 are fixedly connected through the plug-in connecting buckle 100. Quick assembly of the bar rack 320 and the chassis 310 is realized through the plug-in connecting buckle 100, without welding or punching, which significantly reduces manufacturing difficulty and material loss. In some applications, further referring to FIG. 4, a bottom of each of the bar racks 320 is rotatably arranged on the chassis 310, and the bar racks 320 are capable of being rotatably accommodated in the chassis 310 after the plug-in connecting buckles 100 are removed, which completely solves the problem that a traditional drain rack 300 is difficult to reduce a volume thereof due to the fixed bars, and is especially suitable for the high demand of space utilization in domestic or commercial scenarios. In addition, the folding function also enables protecting the bar racks 320 from collision and damage during transportation and prolonging a service life of the bar racks. Further, the drain rack 300 further comprises clamping blocks 330, each of the bar racks 320 comprises a first telescopic rack 321 and a second telescopic rack 322, and each of the clamping block 330 is detachably connected to the respective first telescopic rack 321 and the respective second telescopic rack 322, and drives the respective first telescopic rack 321 to pull out from or slide into the respective second telescopic rack 322. Therefore, a user can adjust a length of the bar rack 320 according to the actual demand without replacing the whole set of components, so as to adapt to use needs of different volumes, and significantly improve applicability and flexibility of the product. In addition, it should be noted that the locking function of the clamping block 330 ensures that the telescopic rack remains stable after adjustment, avoiding height slip caused by self-weight or external force, simplifying the operation of traditional thread adjustment which is complicated, and giving consideration to convenience and reliability. Moreover, the clamping block 330 can be removed conveniently, so that the first telescopic rack 321 and the second telescopic rack 322 are separated, further reducing the packaging volume and the transportation cost.

Other structures and operations of the drain rack 300 according to an embodiment of the present disclosure are known to those of ordinary skills in the art, and will not be described in detail here.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure.

What is claimed is:

1. A plug-in connecting buckle, comprising:
a first connecting part, wherein the first connecting part is provided with a first positioning groove and a first clamping groove which are communicated with each other, openings of the first positioning groove and the first clamping groove are both oriented downward, and the first positioning groove is configured for inserting a first cross bar and driving the first cross bar to be clamped in the first clamping groove; and
a second connecting part integrally connected with the first connecting part, wherein the second connecting part is provided with a second positioning groove and a second clamping groove which are communicated with each other, openings of the second positioning groove and the second clamping groove are both oriented downward, and the second positioning groove is configured for inserting a second cross bar and driving the second cross bar to be clamped in the second clamping groove.

2. The plug-in connecting buckle according to claim 1, wherein a width of the first positioning groove is matched with an outer diameter of the first cross bar, and a width of the second positioning groove is matched with an outer diameter of the second cross bar.

3. The plug-in connecting buckle according to claim 1, wherein the first positioning groove is capable of allowing a first vertical bar connected with an end of the first cross bar to enter and positioning the first vertical bar; and the second positioning groove is capable of allowing a second vertical bar connected with an end of the second cross bar to enter and positioning the second vertical bar.

4. The plug-in connecting buckle according to claim 1, wherein the first clamping groove and the second clamping groove are arranged at a same horizontal position.

5. The plug-in connecting buckle according to claim 1, wherein the first clamping groove and the second clamping groove are vertically arranged.

6. The plug-in connecting buckle according to claim 1, wherein one side of the first connecting part away from the second connecting part is provided with a first clamping part, the first positioning groove is arranged on the first connecting part, and the first clamping groove is arranged on the first clamping part; and one side of the second connecting part away from the first connecting part is provided with a second clamping part, the second positioning groove is arranged on the second connecting part, and the second clamping groove is arranged on the second clamping part.

7. A combined rack, comprising:
a first bar rack provided with a first bar rack and a first vertical bar;
a second bar rack provided with a second cross bar and a second vertical bar; and
a plurality of plug-in connecting buckles, each of which being the plug-in connecting buckle according to claim 1, wherein the first connecting part is configured for insertion and positioning of the first cross bar and the first vertical bar, and the second connecting part is configured for insertion and positioning of the second cross bar and the second vertical bar, so as to fixedly connect the first bar rack and the second bar rack.

8. A drain rack, comprising:
a chassis which is horizontally arranged, wherein the chassis is adapted for placing tableware;
a plurality of bar racks which are all vertically arranged, wherein the plurality of bar racks are respectively connected to a periphery of the chassis; and
a plurality of plug-in connecting buckles, each of which being the plug-in connecting buckle according to claim 1, wherein adjacent bar racks of the plurality of bar racks are fixedly connected through the plug-in connecting buckle.

9. The drain rack according to claim 8, wherein a bottom of each of the bar racks is rotatably arranged on the chassis, and each of the bar racks is capable of being rotatably accommodated in the chassis after the respective plug-in connecting buckle is removed.

10. The drain rack according to claim 8, further comprising a plurality of clamping blocks, each of the bar racks comprises a first telescopic rack and a second telescopic rack, and each of the clamping blocks is detachably connected to the respective first telescopic rack and the respective second telescopic rack, and drives the respective first telescopic rack to pull out from or slide into the respective second telescopic rack.
